(19) United States
(12) Patent Application Publication
(10) Pub. No.: US 2019/0308247 A1
(43) Pub. Date: Oct. 10, 2019

(54) FLAKED TANTALUM POWDER AND PREPARATION METHOD THEREOF

(71) Applicant: NINGXIA ORIENT TANTALUM INDUSTRY CO., LTD., Shizuishan, Ningxi (CN)

(72) Inventors: Xueqing CHEN, Shizuishan, Ningxia (CN); Yuewei CHENG, Shizuishan, Ningxia (CN); Yuezhong MA, Shizuishan, Ningxia (CN); Zhongxiang LI, Shizuishan, Ningxia (CN); Zhidao WANG, Shizuishan, Ningxia (CN); Xia LI, Shizuishan, Ningxia (CN); Dejun SHI, Shizuishan, Ningxia (CN); Zhonghuan ZHAO, Shizuishan, Ningxia (CN)

(21) Appl. No.: 16/317,394

(22) PCT Filed: Jul. 13, 2016
(86) PCT No.: PCT/CN2016/089874

§ 371 Date: Jan. 11, 2019

(51) Int. Cl. B22F 9/20; C22B 34/24; B22F 1/00; H01G 9/042

(52) U.S. Cl. CPC B22F 9/20; C22B 34/24; B22F 2301/20; H01G 9/042; B22F 1/0055; B22F 1/0085

(57) ABSTRACT

Provided are a flaked tantalum powder and method for preparation thereof; said flaked tantalum powder contains 300-1800 ppm of nitrogen, 10-100 ppm of phosphorus, and 1-40 ppm of boron. The flaked tantalum powder has high capacity and low leakage current, good puncture-resistance, and particularly outstanding high-frequency attributes. Doping with nitrogen during oxygen reduction is performed before three thermal treatments are carried out; the solution of performing three thermal treatments and a subsequent process improves the uniformity of distribution of elemental nitrogen and makes up for the deficiency of an oxide film, thereby increasing the pressure resistance of the product, and especially its high-frequency attributes.

### TECHNICAL FIELD

The invention relates to a metal powder and a preparation method thereof, and more specifically relates to a tantalum powder and a preparation method thereof, in particular relates to capacitor-grade medium-high-voltage tantalum powder and a preparation method thereof.

### BACKGROUND TECHNOLOGY

The metal tantalum, being a valve metal, can generate a dense oxidation film on the surface and has unidirectional conductivity. Anode film made of metal tantalum has stable chemical properties (especially stable in acidic electrolyte), a high resistivity (7.5×10¹⁰ Ω·cm), a high dielectric constant (27.6), and a small leakage current. In addition, the anode film also has advantages of a broad working temperature range (−80° C. to 200° C.), a high reliability, a shock resistance, a long service life and the like. Thus it is an ideal material for manufacturing the tantalum capacitor with a small size and a high reliability. Since the tantalum capacitor has many advantages, it is widely used in aviation, space flight, communication, electronic equipments such as computer, mobile phone and the like.

In terms of material classification, tantalum powder specially used for manufacturing capacitor is called capacitor-grade tantalum powder. The tantalum powder can be divided into high-voltage tantalum powder (the working voltage is larger than 40V), medium-voltage tantalum powder (the working voltage is between 20 and 40V, including end point) and low-voltage tantalum powder (the working voltage is less than 20V) according to different use voltages. In recent years, with the rapid development of the electronic technology, there is a higher requirement for the high-frequency characteristic of medium-voltage and high-voltage tantalum powder.

According to the prior art, for a sintered compact made of tantalum powder, the oxygen content in tantalum needs to be strictly limited, and a too high oxygen content can cause an oxide deposition phase on the surface of the tantalum sintered compact, these deposition phases are deposited on the amorphous tantalum pentoxide film formed during the anodizing process, so that the amorphous tantalum pentoxide film can be locally crystallized and even broken, and thereby the reliability of the amorphous tantalum pentoxide film is reduced, the leakage current is large, and the performance of the capacitor is reduced. Doping nitrogen in the tantalum powder can effectively reduce the oxygen content of the tantalum powder, while it can reduce the sintering shrinkage rate and increase the porosity, and can facilitate the immersion of the cathode material and increase the capacity of the capacitor. Therefore, doping nitrogen in the tantalum powder and doping nitrogen in the sintered anode have been an important technology to improve the performance of the tantalum powder and the tantalum capacitor in the tantalum powder production field.

U.S. Pat. No. 5,448,447 (also published as CN1143333C) discloses a method that the leakage current is reduced by at least 28% during high-voltage formation of 100V or more by doping nitrogen of 500-7000 ppm into low-CV tantalum powder of 30000 μFV/g or less. The nitrogen doping method of the tantalum powder is characterized in that nitrogen doping is carried out in the deoxidation process of the final step of the manufacturing procedure, and then no high-temperature heat treatment is carried out again.

JP Kokai No.: 2002-30301A discloses a tantalum powder containing nitrogen of 500-30000 ppm, and in which the deviation of the nitrogen content among respective particles is 100% or less, the tantalum powder has a better breakdown voltage compared with the tantalum powder without nitrogen doped. The nitrogen doping method of the tantalum powder is a method wherein the nitrogen doping is carried out in a reaction container such as a rotary kiln in a rotating state in the deoxidation process of final step of the manufacturing procedure, with heating to 850° C., and then no heat treatment at 900° C. or higher is carried out as well. What the patent/application investigates is a nitrogen doping method and a nitrogen-containing tantalum powder which are suitable for high-capacity tantalum powder of 30000 μFV/g or higher.

CN1363102A and CN100528418C respectively disclose a nitrogen doping method for tantalum and niobium metal powder, wherein the content of nitrogen doped is between 100 to 6000 ppm. The nitrogen doping method described in the two patents is also carried out in the final step, wherein the nitrogen doping temperature is 100-600° C.; and then no heat treatment is carried out as well.

CN1433485A and CN1872461A describe a reparation method of the nitrogen-containing tantalum powder, wherein nitrogen is introduced in the process of reducing the metal compound with the reducing agent, so that nitrogen is contained in the metal. Because of the reduction reaction process and the nitrogen doping at 800° C. or higher, the reaction between tantalum and nitrogen in the nitrogen doping process is too fast, so that the concentration of nitrogen in each part in the reaction container is not consistent, and therefore it is difficult to ensure that the nitrogen doping of the particles is uniform.

The above existing nitrogen doping technology discloses the nitrogen doping method of a same kind, namely nitrogen doping is carried out in the final step, and then no high-temperature heat treatment is carried out.

By investigating, the inventor finds that when the existing method is used for nitrogen doping of tantalum powder with high capacity of 30000 μFV/g or higher, the leakage current and the capacity of the tantalum powder could be improved. On the other hand, for the tantalum powder of 30000 μFV/g or lower, in particular the flaked medium-high-voltage tantalum powder, when nitrogen doping is carried our in the final step, and no high-temperature heat treatment is carried out, the presence of the nitrogen element has no significant effect to the improvement of the leakage current of the medium-high-voltage tantalum powder of 30000 μFV/g or lower, in particular the flaked tantalum powder, or in other words, no significant effect to the increment of the capacity of the tantalum powder.

Thus, in order to improve the presence formation of nitrogen elements and to make the distribution of nitrogen elements more uniform, so as to make the doped nitrogen element play a better role, a novel nitrogen doping method and the flaked tantalum powder containing nitrogen of 300-1800 ppm are developed in the invention, thereby the leakage current and the voltage resistance, especially high-frequency characteristics of the medium-high-voltage flaked tantalum powder of 30000 μFV/g or lower are further improved, so that the medium-high-voltage flaked tantalum powder can be better used in the field which has a higher requirement for the high-frequency characteristic.

### SUMMARY OF THE INVENTION

In view of the above technical problems, one aim of the invention is to provide a flaked tantalum powder, especially medium-high-voltage flaked tantalum powder. The flaked tantalum powder preferably contains nitrogen, phosphorus and/or boron, and is preferably suitable for high-frequency capacitors. Another aim of the invention is to provide a method for preparing the medium-high-voltage flaked tantalum powder.

Although the method disclosed by the present invention is especially suitable for medium-high-voltage flaked tantalum powder of 30000 μV/g or lower, but is also suitable for medium-high-voltage flaked tantalum powder of more than 30000 μFV/g.

According to the technical solution described below, the present invention realizes one or more of the above aims.

A flaked tantalum powder preferably suitable for high-frequency capacitors, it is characterized in that the powder contains nitrogen of 300-1800 ppm, preferably 400-1600 ppm, more preferably 500-1500 ppm, and most preferably 700-1300 ppm; and phosphorus of 10-100 ppm, preferably 20-80 ppm, more preferably 30-70 ppm; and/or boron of 1 to 80 ppm, preferably 10 to 65 ppm, more preferably 20 to 50 ppm.

A flaked tantalum powder preferably suitable for high-frequency capacitors, it is characterized in that the electrolytic capacitor anode made from the powder has a capacity of about 3000-30000 μV/g under the condition of an energizing voltage of 100-250V and a testing frequency of 5000-30000 Hz.

Through a large amount of research, the inventors have surprisingly found that if the nitrogen content is too low, it cannot inhibit sintering, and cannot increase the capacity; if the nitrogen content is too high, the hardness of the tantalum powder is increased, so that the performance of the compact can be reduced, and even large abrasion to the grinding tool can be caused which may shorten the service life of the grinding tool, thus the nitrogen content of 300-1800 ppm is more suitable.

The oxygen content of the flaked tantalum powder is preferably 800-3000 ppm, and the Scott bulk density is not particularly limited, preferably 1.4-2.0 g/cm³, preferably 1.55-1.9 g/cm³.

A method for preparing flaked tantalum powder comprising the steps of:
1) subjecting the flaked tantalum powder to first heat treatment
2) subjecting the first heat treated tantalum powder to first deoxidation;
3) subjecting the first deoxidized tantalum powder to low temperature nitridation;
4) subjecting the low-temperature nitrided tantalum powder to second heat treatment; and optionally
5) subjecting the second heat-treated tantalum powder to second deoxidation, and then optionally to pickling, water washing, drying, and sieving to obtain the flaked tantalum powder according to the invention.

In a preferred embodiment, the low temperature nitridation of step 3) is started in the cooling process of the deoxidation treatment of step 2) (particularly when temperature is lowered to 500° C. or lower, for example, 500-240° C.). The embodiment has the advantage that the tantalum powder does not need to be re-heated for low-temperature nitridation treatment, and more energy is saved.

In another embodiment, the tantalum powder is reheated to start the low temperature nitridation of step 3) after the temperature in the deoxidation treatment of step 2) is lowered to room temperature.

The tantalum powder used in step 1) is flaked tantalum powder prepared by any known methods, for example, the flaked tantalum powder obtained by flaking by vibration ball milling or stirring ball milling on the tantalum powder reduced with sodium and by carrying out pickling and impurity removal. Preferably, the heat treatment in step 1) is accomplished under a vacuum condition. Preferably, the heat treatment temperature is 1200° C.-1600° C., preferably 1250-1500° C., more preferably 1300-1450° C. In a preferred embodiment, the flaked tantalum powder as a raw material is obtained by the following manner: the tantalum powder reduced with sodium is subjected to ball milling, pickling and impurity removal to obtain the flaked tantalum powder, optionally, the flaked tantalum powder is doped with ammonium dihydrogen phosphate (which can also be ammonium hexafluorophosphate) of 10-100 ppm based on the amount of phosphorus element, and/or boric acid of 1-80 ppm based on the amount of boron element, and is heated to 1200-1600° C. under a vacuum condition for heat treatment.

For step 2) or step 5), the temperature and time of temperature-keeping of the deoxidation are not specifically limited, for example, the temperature can be kept at 800-1000° C. (preferably 750-980° C., 750-900° C. or 850-950° C.) for 3-6 hours (preferably 3-5 hours or 4-6 hours).

Preferably, the deoxidation in step 2) is carried out by doping magnesium powder into the tantalum powder obtained in step 1) in proportion (for example, magnesium powder of 0.5-5 wt % based on the weight of the tantalum powder), and heating to the temperature of 700-1000° C. in an argon atmosphere. More preferably, the temperature is 800-900° C. For example, deoxidation can be accomplished in the following manner: the product obtained in step 1) is doped in proportion with magnesium powder of 0.5-5 wt % based on the weight of the tantalum powder, and is heated to the temperature of 700-1000° C. in an argon atmosphere, then the temperature is lowered to 240-500° C. (for example, 300-450° C. or 400° C.) and the inert atmosphere is replaced into nitrogen atmosphere, and the temperature is kept for 80-150 minutes (for example, 120 minutes), after cooling and passivating, the product is discharged out of furnace and is sieved, then is subjected to pickling and impurity removal and drying.

Preferably, low-temperature nitridation in step 3) refers to nitriding at the temperature of 500° C. or lower. Preferably, low-temperature nitridation is carried out in the following manner: after the temperature in step 2) is lowered to 240-500° C. (for example, 300-450° C. or about 400° C.), the inert atmosphere is replaced into nitrogen atmosphere (preferably keeping the atmosphere in the furnace as positive pressure, for example, 0-0.1 MPa, for example, 0-0.01 MPa), the temperature is kept for 80-150 minutes (for example, 90-140 minutes or about 120 minutes), after cooling and passivating, the product is discharged out of furnace. Preferably, after passivating and discharging out of furnace, the tantalum powder is subjected to sieving, pickling, impurity removal and drying.

Preferably, the second heat treatment in step 4) comprises heating to 1200-1600° C., and keeping the temperature for 30-180 minutes, preferably 30-120 minutes under a vacuum condition.

The deoxidation in step 5) can be any deoxidation method known in the prior art. In one embodiment, the deoxidation process in step 5) is as same as that in step 2). In another embodiment, the deoxidation process in step 5) is different from that in step 2).

With regard to step 3), the inventors have surprisingly found that if nitrogen doping treatment is carried out at a high temperature of 500° C. or higher, the diffusion speed of the nitrogen is increased, the oxidation film is rapidly diffused, and the tantalum powder is exposed, thus the exothermal reaction between nitrogen and the tantalum of the uppermost layer in contacted with nitrogen rapidly progresses, and even the reaction is out-of-control locally, while the powder at the lower layer is in a state that the nitrogen cannot be rapidly supplied. As a result, the nitrogen content of the powder at the surface is very large, and the nitrogen content of the powder in the lower layer is very small, and the nitrogen content difference among the particles becomes very large, and it is possible to generate nitride crystals (such as Ta2 Ney TaN) and the like. The research of the inventors proves that if nitrogen doping treatment is carried out only at 500° C. or lower, and then no high-temperature heat treatment of 1000° C. or higher is carried out, the nitrogen content only stays on the surface of the tantalum powder, the diffusion does not reach a enough depth, and not be uniform, thus it has not a significant effect to the improvement of the leakage current of the tantalum powder of 30000 μFV/g or lower, particularly the medium-high-voltage flaked tantalum powder, or in other words, has not a significant effect to increase the capacity of the tantalum powder. By combing with the characteristics of a conventional medium-high-voltage tantalum powder production process, in the method of the present invention, low-temperature nitrogen doping is carried out in the deoxidation process, and then high-temperature heat treatment is further carried out; thereby the above problems are avoided.

It should be understood that for the doping of a phosphorus element and/or a boron element, one element may be doped, or two elements may be doped at the same time, and it can optionally to add a compound containing phosphorus and/or boron before the heat treatment of step 1), or to add a compound containing phosphorus and/or boron together with magnesium powder during the deoxidation treatment of step 2), and it can also be selected to add a compound containing phosphorus and/or boron after step 5).

### Specific Implementation Mode

A Fisher average particle size (FSSS/μm) for describing tantalum metal particles disclosed in this specification is determined with a Fisher sub-screening instrument. The oxygen and nitrogen contents analysis are analyzed with ON-600 oxygen nitrogen tester of LECO Company of United States. The phosphorus content is analyzed with 2800 UV/VIS spectrophotometer of Eunic (Shanghai) Instrument Company. The contents of iron and boron and impurity elements are analyzed with DV-5 DC arc optoelectronic spectrometer of Beld Company of United States, Scott bulk density (SBD, g/cm³) is obtained by testing according to a method specified in China National Standard GB5060-85.

For further understanding of the invention, the embodiments of the present invention are described in conjunction with the Examples and the accompanying tables, but it should be understood that the descriptions are only for the specification of the features and advantages of the present invention, but not intend to limit the scope of the claims of the present invention.

The raw materials adopted herein are commercially available, such as commercially available from Ningxia Orient Tantalum Industry Co. Ltd.

### EXAMPLE 1

The flaked tantalum powder obtained by adopting the prior art was used as a raw material 1. The parameters of the flaked tantalum powder obtained by testing are shown in Table 1. 5 Kg of raw material 1 was taken, and boric acid of 40 ppm based on the amount of boron elements was added, after uniformly mixing and carrying out agglomeration treatment on the mixture, the mixture was put into a heat treatment furnace, the temperature was kept at 1450° C. for 60 minutes followed by cooling and passivating, after that, discharging out of the furnace, sieving by a 60-mesh screen and carrying out magnetic separation. Then, the magnesium powder of 1.5% based on the weight of the tantalum powder was doped, the temperature was raised to 900° C. and was kept for 4 hours under the protection of inert gas followed by lowering the temperature and cooling to 450° C., after that, evacuation replacement was carried out, and high-purity nitrogen was filled until the pressure reaching a positive pressure (+0.01 MPa), then the temperature was kept for 60 minutes, and cooling and passivating were carried out, after that, discharging out of the furnace, and after carrying out pickling and impurity removal with the prior art process, it was put into a heat treatment furnace again, then the temperature was kept at 1430° C. for 60 minutes, and then cooling and passivating, after that, discharging out of the furnace, sieving by a 60-mesh screen and carrying out magnetic separation.

Next, the magnesium powder of 1.5% based on the weight of the tantalum powder was doped, the temperature was raised to 900° C. and was kept for 4 hours under the protection of inert gas followed by cooling and passivating, after that, discharging out of the furnace, and carrying out pickling and impurity removal with the prior art process to obtain a finished product. The chemical impurities and the physical properties of the finished product are shown in Table 2.

The powder sample was pressed and formed into a compact that had a density of 5.0 g/cm³, and a weight of the core powder of 0.20 g. The compact was sintered at 1600° C. for 15 minutes to obtain a sintered compact. The sintered compact was energized by 150 v in a 0.01% phosphoric acid solution. The capacity and loss of the sintered compact were measured at a test frequency of 5000-30000 Hz. The measured electrical properties of the sample are listed in Table 3.

### COMPARATIVE EXAMPLE 1

The raw material was the same as that used in Example 1. 5 Kg of raw material was taken, and boric acid of 40 ppm based on the amount of boron element was added, after uniformly mixing and carrying out agglomeration treatment on the mixture, the mixture was put into a heat treatment furnace, the temperature was kept at 1450° C. for 60 minutes followed by cooling and passivation, after that, discharging out of the furnace, sieving by a 60-mesh screen and carrying out magnetic separation. Then, the magnesium powder of 1.5% based on the weight of the tantalum powder was doped, the temperature was raised to 900° C. and was kept for 4 hours under the protection of inert gas followed by lowering the temperature, and cooling and passivating were carried out, after that, discharging out of the furnace, and after carrying out pickling and impurity removal with the prior art process, it was put into a heat treatment furnace again, then the temperature was kept at 1430° C. for 60 minutes, and cooling and passivating were carried out, after that, discharging out of the furnace, sieving by a 60-mesh screen and carrying out magnetic separation.

Next, the magnesium powder of 1.3% based on the weight of the tantalum powder was doped, the temperature was raised to 900° C. and was kept for 4 hours under the protection of inert gas followed by lowering the temperature and cooling to 450° C., after that, evacuation replacement was carried out, and high-purity nitrogen was filled until the pressure reaching a positive pressure (+0.01 MPa), then the temperature was kept for 60 minutes, and cooling and passivating were carried out, after that, discharging out of the furnace, and carrying out pickling and impurity removal with the prior art process to obtain a finished product. The chemical impurities and the physical properties of the finished product are shown in Table 2.

The above powder was subjected to electrical properties detection by using the same condition as Example 1. The measured electrical properties of the sample are listed in Table 3.

### EXAMPLE 2

The same raw material as Example 1 was used. Its parameters obtained by testing are shown in Table 1. After agglomeration treatment, the raw material was put into a heat treatment furnace, the temperature was kept at 1400° C. for 60 minutes followed by cooling and passivating, after that, discharging out of the furnace, sieving by a 60-mesh screen and carrying out magnetic separation, and then ammonium hexafluorophosphate of 70 ppm based on the amount of phosphorus element was added, and magnesium powder of 2.0% based on the weight of the tantalum powder was doped with uniformly mixing, the temperature was raised to 880° C. and was kept for 4 hours under the protection of the inert gas followed by lowering the temperature and cooling to 350° C., then evacuation replacement was carried out, and high-purity nitrogen was filled until the pressure reaching a positive pressure (+0.01 MPa), then the temperature was kept for 60 minutes, and cooling and passivating were carried out, after that, discharging out of the furnace, and after carrying out pickling and impurity removal with the prior art process, it was put into a heat treatment furnace again, then the temperature was kept at 1400° C. for 60 minutes, and cooling and passivating were carried out, after that, discharging out of the furnace, sieving by a 60-mesh screen and carrying out magnetic separation.

Next, the magnesium powder of 1.8% based on the weight of the tantalum powder was doped, the temperature was raised to 880° C. and was kept for 4 hours under the protection of inert gas followed by cooling and passivating, after that, discharging out of the furnace, and carrying out pickling and impurity removal with the prior art process to obtain a finished product. The chemical impurities and the physical properties of the finished product are shown in Table 2.

The above powder sample was pressed and formed into a compact that had a density of 5.0 g/cm′ and a weight of the core powder of 0.20 g. The compact was sintered in a vacuum furnace of 10⁻³ Pa at 1700° C. for 15 minutes to obtain a sintered compact. The sintered compact was energized by 140 v in a 0.01% phosphoric acid solution. The capacity and loss of the sintered compact were measured at a test frequency of 5000-30000 Hz. The measured electrical properties of the sample are listed in Table 3.

### COMPARATIVE EXAMPLE 2

The same raw material as Example 2 was used. After agglomeration treatment, the raw material was put into a heat treatment furnace, the temperature was kept at 1400° C. for 60 minutes followed by cooling and passivating, after that, discharging out of the furnace, sieving by a 60-mesh screen and carrying out magnetic separation, and then magnesium powder of 2.0% based on the weight of the tantalum powder was doped with uniformly mixing, and the temperature was raised to 880° C. and was kept for 4 hours under the protection of the inert gas followed by lowering the temperature, cooling and passivating, after that, discharging out of the furnace, and after carrying out pickling and impurity removal with the prior art process, it was put into a heat treatment furnace again, then the temperature was kept at 1400° C. for 60 minutes, and cooling and passivating were carried out, after that, discharging out of the furnace, sieving by a 60-mesh screen and carrying out magnetic separation.

Next, the magnesium powder of 1.8% based on the weight of the tantalum powder was doped, and ammonium hexafluorophosphate of 70 ppm based on the amount of phosphorus element was added, the temperature was raised to 880° C. and was kept for 4 hours under the protection of inert gas followed by lowering the temperature and cooling to 350° C., then evacuation replacement was carried out, and high-purity nitrogen was filled until the pressure reaching a positive pressure, such as +0.01 MPa, then the temperature was kept for 60 minutes, and cooling and passivating were carried out, after that, discharging out of the furnace, and carrying out pickling and impurity removal with the prior art process to obtain a finished product. The chemical impurities and the physical properties of the finished product are shown in Table 2.

The above powder was subjected to electrical properties detection by using the same condition as Example 2. The measured electrical properties of the sample are listed in Table 3.

### EXAMPLE 3

The flaked tantalum powder obtained with the prior art process was used as a raw material 2. Its properties are shown in Table 1. 5 Kg of raw material 2 was taken, and ammonium dihydrogen phosphate of 80 ppm base on the amount of phosphorus element was added, after uniformly mixing and carrying out agglomeration treatment on the mixture, the mixture was put into a heat treatment furnace, the temperature is kept at 1380° C. for 60 minutes followed by cooling and passivating, after that, discharging out of the furnace, sieving by a 60-mesh screen and carrying out magnetic separation. Then, the magnesium powder of 2.5% based on the weight of the tantalum powder was doped, the temperature was raised to 800° C. and was kept for 4 hours under the protection of inert gas followed by lowering the temperature and cooling to 320° C., after that, evacuation replacement was carried out, and high-purity nitrogen was filled until the pressure reaching a positive pressure (+0.01 MPa), then the temperature was kept for 60 minutes, and cooling and passivating were carried out, after that, discharging out of the furnace, and after carrying out pickling and impurity removal with the prior art process, it was put into a heat treatment furnace again, then the temperature was kept at 1450° C. for 60 minutes, and cooling and passivating were carried out, after that, discharging out of the furnace, sieving by a 60-mesh screen and carrying out magnetic separation.

Next, the magnesium powder of 2.0% based on the weight of the tantalum powder was doped, the temperature was raised to 860° C. and was kept for 4 hours under the protection of inert gas followed by cooling and passivating, after that, discharging out of the furnace, and carrying out pickling and impurity removal with the prior art process to obtain the finished product. The chemical impurities and the physical properties of the finished product are shown in Table 2.

The above powder sample was pressed and formed into a compact that had a density of 5.0 g/cm′ and a weight of the core powder of 0.15 g. The compact was sintered at 1500° C. for 20 minutes to obtain a sintered compact. The sintered compact was energized by 140 v in a 0.01% phosphoric acid solution. The capacity and loss of the sintered compact were measured at a test frequency of 5000-30000 Hz. The measured electrical properties of the sample are listed in Table 3.

### COMPARATIVE EXAMPLE 3

The raw material was the same as that used in Example 3. 5 Kg of raw material was taken, and ammonium dihydrogen phosphate of 80 ppm based on the amount of phosphorus element was added, after uniformly mixing and carrying out agglomeration treatment on the mixture, the mixture was put into a heat treatment furnace, the temperature was kept at 1380° C. for 60 minutes followed by cooling and passivating, after that, discharging out of the furnace, sieving by a 60-mesh screen and carrying out magnetic separation. Then, the magnesium powder of 2.5% based on the weight of the tantalum powder was doped, the temperature was raised to 860° C. and the temperature was kept for 4 hours under the protection of inert gas followed by lowering the temperature, cooling and passivating, after that, discharging out of the furnace, and after carrying out pickling and impurity removal with the prior art process, it was put into a heat treatment furnace again, then the temperature was kept at 1450° C. for 60 minutes, and cooling and passivating were carried out, after that, discharging out of the furnace, sieving by a 60-mesh screen and carrying out magnetic separation.

Next, the magnesium powder of 2.0% based on the weight of the tantalum powder was doped, the temperature was raised to 860° C. and was kept for 4 hours under the protection of inert gas followed by lowering the temperature and cooling to 320° C., then evacuation replacement was carried out, and high-purity nitrogen was filled until the pressure reaching a positive pressure, such as +0.01 MPa, then the temperature was kept for 60 minutes, and cooling and passivating were carried out, after that, discharging out of the furnace, and carrying out pickling and impurity removal with the prior art process to obtain a finished product. The chemical impurities and the physical properties of the finished product are shown in Table 2.

The above powder was subjected to electrical properties detection by using the same condition as Example 3. The measured electrical properties of the sample are listed in Table 3.

### EXAMPLE 4

The flaked tantalum powder obtained with the prior art process was used as a raw material 3. Its properties are shown in Table 1. 5 Kg of raw material 3 was taken, and boric acid of 40 ppm based on the amount of boron elements was added, after uniformly mixing and carrying out agglomeration treatment on the mixture, the mixture was put into a heat treatment furnace, the temperature was kept at 1520° C. for 60 minutes followed by cooling and passivating, after that, discharging out of the furnace, sieving by a 60-mesh screen and carrying out magnetic separation. Then, the magnesium powder of 1.5% based on the weight of the tantalum powder was doped, the temperature was raised to 920° C. and was kept for 4 hours under the protection of inert gas followed by lowering the temperature and cooling to 420° C., then evacuation replacement was carried out, and high-purity nitrogen was filled until the pressure reaching a positive pressure (+0.01 MPa), then the temperature was kept for 60 minutes followed by cooling and passivating, after that, discharging out of the furnace, and after carrying out pickling and impurity removal with the prior art process, it was put into a heat treatment furnace again, then the temperature was kept at 1520° C. for 60 minutes, and cooling and passivating were carried out, after that, discharging out of the furnace, sieving by a 60-mesh screen and carrying out magnetic separation to obtain a finished product. The chemical impurities and physical properties of the finished product are shown in Table 2.

The above powder sample was pressed and formed into a compact that had a density of 6.0 g/cm′ and a weight of the core powder of 3 g. The sintered compact that was obtained by sintering at 1700° C. for 30 minutes was energized by 150V in a 0.01% phosphoric acid solution. The capacity and loss of the sintered compact were measured at a test frequency of 5000-30000 Hz. The measured electrical properties of the sample are listed in Table 3.

### COMPARATIVE EXAMPLE 4

The raw material was the same as that used in Example 4. 5 Kg of raw material was taken, and boric acid of 40 ppm based on the amount of boron elements was added, after uniformly mixing and carrying out agglomeration treatment on the mixture, the mixture was put into a heat treatment furnace, the temperature was kept at 1520° C. for 60 minutes followed by cooling and passivating, after that, discharging out of the furnace, sieving by a 60-mesh screen and carrying out magnetic separation. Then, the magnesium powder of 1.5% based on the weight of the tantalum powder was doped; the temperature was raised to 920° C. and was kept for 4 hours under the protection of inert gas, then the temperature is lowered.

Then, the temperature was raised to 450° C. under the protection of inert gas, after that, evacuation replacement was carried out, and high-purity nitrogen was filled until the pressure reaching a positive pressure (+0.01 MPa), then the temperature was kept for 60 minutes followed by cooling and passivating, after that, discharging out of the furnace to obtained a finished product. The chemical impurities and the physical properties of the finished product are shown in Table 2.

The above powder was subjected to electrical properties detection by using the same condition as Example 4. The measured electrical properties of the sample are listed in Table 3.

TABLE 1
Main impurity contents and physical properties of raw materials
used in the present invention

| | O | N | Fe | Fsss | SBD |
|---|---|---|---|---|---|
| | ppm | ppm | ppm | (μm) | (g/cc) |
| raw material 1 | 6020 | 120 | 20 | 0.65 | 1.00 |
| raw material 2 | 8910 | 110 | 19 | 0.48 | 0.91 |
| raw material 3 | 3520 | 80 | 18 | 0.90 | 1.08 |

TABLE 2
Main impurity contents and physical properties of samples of the
Examples and Comparative Examples of the present invention

| | O | N | Fe | B | P | Fsss | SBD |
|---|---|---|---|---|---|---|---|
| | ppm | ppm | ppm | ppm | ppm | (μm) | (g/cc) |
| Example 1 | 2020 | 1400 | 26 | 35 | 20 | 2.65 | 1.72 |
| Comparative | 1940 | 1580 | 25 | 32 | 22 | 2.70 | 1.69 |
| Example 1 | | | | | | | |
| Example 2 | 1820 | 780 | 23 | — | 58 | 2.36 | 1.68 |
| Comparative | 1990 | 1040 | 25 | — | 62 | 2.47 | 1.76 |
| Example 2 | | | | | | | |
| Example 3 | 2490 | 770 | 23 | — | 72 | 2.85 | 1.78 |
| Comparative | 2480 | 870 | 24 | — | 71 | 2.38 | 1.68 |
| Example 3 | | | | | | | |
| Example 4 | 1530 | 570 | 29 | 28 | 10 | 4.59 | 1.87 |
| Comparative | 1770 | 520 | 27 | 24 | 10 | 4.53 | 1.90 |
| Example 4 | | | | | | | |

TABLE 3
Main electrical properties of samples of the Examples and Comparative Examples
of the present invention under high frequency test

| Electrical | | Leakage | | | | |
|---|---|---|---|---|---|---|
| properties | | current | Capacity | | Breakdown | Volume |
| test | | K value | (CV) | Loss | voltage | shrinkage |
| condition | | μA/μFV | μFV/g | (tg δ) % | (VB) V | (SHV) % |
| 5000 Hz | Example 1 | 2.2 × 10⁻⁴ | 16407 | 98.8 | 175 | 7.1 |
| | Comparative | 3.8 × 10⁻⁴ | 13947 | 97.3 | 170 | 11.9 |
| | Example 1 | | | | | |
| 20000 Hz | Example 1 | 3.3 × 10⁻⁴ | 11110 | 200.4 | 175 | 7.1 |
| | Comparative | 5.9 × 10⁻⁴ | 9060 | 191.2 | 170 | 11.9 |
| | Example 1 | | | | | |
| 8000 Hz | Example 2 | 1.5 × 10⁻⁴ | 12236 | 90.5 | 210 | 14.8 |
| | Comparative | 2 × 10⁻⁴ | 10127 | 88 | 210 | 17.6 |
| | Example 2 | | | | | |
| 25000 Hz | Example 2 | 2.3 × 10⁻⁴ | 7784 | 174.4 | 210 | 14.8 |
| | Comparative | 3.2 × 10⁻⁴ | 6337 | 157.2 | 214 | 17.6 |
| | Example 2 | | | | | |
| 5000 Hz | Example 3 | 4.0 × 10⁻⁴ | 21483 | 85.2 | 205 | 16.9 |
| | Comparative | 4.5 × 10⁻⁴ | 17757 | 90.3 | 205 | 20.7 |
| | Example 3 | | | | | |
| 15000 Hz | Example 3 | 5.8 × 10⁻⁴ | 14054 | 196.0 | 205 | 16.9 |
| | Comparative | 6.0 × 10⁻⁴ | 12972 | 200.9 | 205 | 20.7 |
| | Example 3 | | | | | |
| 5000 Hz | Example 4 | 1.5 × 10⁻⁴ | 8158 | 71.0 | 269 | 14.1 |
| | Comparative | 1.8 × 10⁻⁴ | 6154 | 72.4 | 266 | 17.7 |
| | Example 4 | | | | | |
| 30000 Hz | Example 4 | 1.9 × 10⁻⁴ | 4967 | 418 | 269 | 14.1 |
| | Comparative | 2.0 × 10⁻⁴ | 4419 | 430 | 266 | 17.7 |
| | Example 4 | | | | | |

It is known from these values in the tables, the leakage current of the samples in the Examples is significantly reduced compared with those in the Comparative Examples. For example, the leakage current is reduced by at least 10%, and the capacity is significantly increased, for example, 5% or more. This has a great advantage for the tantalum powder with high-frequency characteristics, and is also unexpected.

It can be known from the data of Tables 2 and 3 that the tantalum powders obtained by the Examples have a small density ratio before and after sintering, the excess shrinkage caused by sintering is inhibited, so that the capacity is high under the high-frequency test condition, and the leakage current is relatively small; while for the tantalum powder obtained by the Comparative Examples, since they are not subjected to high-temperature treatment after nitrogen doping, the shrinkage caused by sintering is large, so that the capacity is relatively low under the high-frequency test condition, and the leakage current is relatively large.

1. A method for preparing flaked tantalum powder comprising:
1) subjecting flaked tantalum powder to a first heat treatment;
2) subjecting the first heat treated tantalum powder to a first deoxidation;
3) subjecting the first deoxidized tantalum powder to low temperature nitridation;
4) subjecting the low-temperature nitrided tantalum powder to a second heat treatment; and optionally
5) subjecting the second heat-treated tantalum powder to a second deoxidation, and then optionally subjecting the second deoxidized tantalum powder to one or more processes selected from the group consisting of pickling, water washing, drying, and sieving to obtain a finished flaked tantalum powder.

2. The method according to claim 1, wherein the flaked tantalum powder of 1) is first prepared by reducing potassium fluotantalate with sodium, and subjecting the tantalum powder produced thereby to ball milling, pickling and impurity removal.

3. The method according to claim 1, wherein the first deoxidation of 2) comprises keeping the temperature within the range of from about 800 to about 1000° C. for a period of time of from about 3 to about 6 hours.

4. The method according to claim 1, wherein the low temperature nitridation of 3) begins (a) when the temperature of the first deoxidation treatment of 2) is lowered, or (b) by reheating after the temperature in the deoxidation treatment of 2) is lowered to room temperature.

5. A flaked tantalum powder suitable for use in a high frequency capacitor, the flaked tantalum powder comprising nitrogen within the range of from about 300 to about 1800 ppm, and optionally phosphorus and/or boron.

6. An anode of an electrolytic capacitor comprising the flaked tantalum powder according to claim 5, wherein the anode has a capacity of about 3000 to 30000 μFV/g under the condition of an energization voltage of 100-250 V and a test frequency of 5000-30000 Hz.

7. The flaked tantalum powder according to claim 5, wherein the tantalum powder contains boron within the range of from about 1 to about 80 ppm.

8. The flaked tantalum powder according to claim 5, wherein the tantalum powder has an oxygen content of from about 800 to about 3000 ppm.

9. The flaked tantalum powder of claim 5, wherein the tantalum powder has a phosphorus content of from about 10 to about 100 ppm.

10. The flaked tantalum powder according to claim 5, wherein the Scott bulk density of the power is within the range of from about 1.4 to about 2.0 g/cm³.

11. The method according to claim 2, wherein ball milling is selected from vibration ball milling or agitating ball milling.

12. The method according to claim 3, wherein the first deoxidation of 2) comprises keeping the temperature within the range of from about 850 to about 950° C. for a period of time of from about 4 to about 6 hours.

13. The method according to claim 3, wherein the first deoxidation of 2) comprises keeping the temperature within the range of from about 750 to about 980° C. for a period of time of from about 3 to about 5 hours.

14. The method according to claim 4, wherein the low temperature nitridation of 3) begins when the temperature of the first deoxidation treatment of 2) is lowered to a temperature within the range of from about 500 to about 240° C.

15. The flaked tantalum powder of claim 5, wherein the tantalum powder comprises nitrogen within the range of from about 500 to about 1,500 ppm.

16. The flaked tantalum powder of claim 15, wherein the tantalum powder comprises nitrogen within the range of from about 700 to about 1,300 ppm.

17. The flaked tantalum powder of claim 7, wherein the flaked tantalum powder comprises from about 10 to about 65 ppm of boron.

18. The flaked tantalum powder of claim 17, wherein the flaked tantalum powder comprises from about 20 to about 50 ppm of boron.

19. The flaked tantalum powder of claim 10, wherein the Scott bulk density of the power is within the range of from about 1.55 to about 1.9 g/cm³
